(19) United States
(12) Patent Application Publication
(10) Pub. No.: US 2005/0274815 A1
(43) Pub. Date: Dec. 15, 2005

(54) Device for drinks and the sue of a material for such a device

(76) Inventors: Lars Bergholtz, Lerberget (SE); Jerry Bengtsson, Modena (IT)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/481,085

(22) PCT Filed: Jun. 17, 2002
(86) PCT No.: PCT/SE02/01167

§ 371 Date: Dec. 17, 2003

(30) Foreign Application Priority Data
Jun. 21, 2001 (SE) 0102247-4

(51) Int. Cl. E03B 9/20; A61J 15/00; A47G 21/18

(52) U.S. Cl. 239/16; 239/33

(57) ABSTRACT

Drinking straw for drinks, which is made of a material which includes one or more polyolefins, which polyolefin or which polyolefins include one or more inorganic filler materials. The invention is also directed towards the use of such a material in drinking straws for drinks.

### TECHNICAL FIELD

The present invention relates to a disposable drinking straw for drinks. More specifically, the invention relates to the use of a special material for designing drinking straws for drinks.

### STATE OF THE ART AND PROBLEMS

Drinking straws which are to be used only once are conventionally manufactured from polyolefin material, such as polypropylene or polyethene. When such drinking straws are used in tumblers, cups, cans, bottles, etc., a problem is that the drinking straw floats up in the drink. Particularly in naturally or artificially carbonated drinks, the problem of the drinking straw floating up is especially great since bubbles of carbon dioxide are formed or settle on the surfaces which are defined by the walls of the drinking straw, something which in turn increases the net lift on the drinking straw. In connection with the type of drinking cup which is frequently used in hamburger restaurants, etc., i.e. drinking cups made of carton or plastic-coated carton, this problem is solved by means of a plastic lid which possesses a centrally arranged hole which is formed from intersecting slits and whose purpose is to hold the drinking straw fast. Thus, as a result of the friction against these slits, it is not possible for the drinking straw to float up. While such lids certainly have a function in preventing the drink from slopping over, this function is in fact only required when the drinking cup is to be taken away from the restaurant (“take-away”). When the drink is to be consumed in the restaurant itself, the use of a lid only means an additional cost and an environmental burden and also an additional operation for the personnel when they are to place the lid on a drinking cup.

The known types of drinking straw also suffer from disadvantages in other respects, i.e. first and foremost as regards expense and from the environmental point of view, but also as concerns physical properties such as the lack of rigidity and the tactile feel of the material, which is “plasticky”.

### ACCOUNT OF THE INVENTION AND ITS ADVANTAGES

The present invention aims to offer a solution to the abovementioned complex of problems. In particular, the invention aims to offer a disposable drinking straw for liquid drinks which does not float up when it is placed freely in the drink, in particular a carbonated drink. The invention also aims to offer a drinking straw for drinks, which drinking straw provides improved environmental properties for a lower cost than the current type of drinking straw which is manufactured entirely from polymeric materials. The invention furthermore aims to offer a drinking straw which is manufactured in a material which results in the drinking straw having a higher degree of rigidity than known types of drinking straw made only of polymeric materials, and in the drinking straw having a pleasanter, non-plasticky, feel.

The present invention therefore offers a drinking straw as is defined in Patent Claim 1. The present invention furthermore relates to the use of a material, which is known per se, for drinking straws for drinks, in accordance with Patent Claim 8.

The concept behind the invention is that of finding a material which is cheaper and more environmentally friendly than known materials for drinking straws and which, at the same time, is denser and more rigid and has a pleasant feel like that of paper. In addition, the material should be well suited for the automated mass production of drinking straws, which means that it should be cheap and simple to handle for the automated mass production of drinking straws. According to the invention, the advantage is also achieved that a smaller quantity of polymeric material is required and that the gauge of the wall of the drinking straw can be made thinner than is conventionally the case, thereby resulting in a decrease in material consumption.

The material according to the invention for these purposes consists, preferably entirely, of one or more polyolefins which include one or more inorganic filler materials, in particular one or more types of inorganic mineral particle.

According to one aspect of the invention, the said one or more polyolefins include a propene-based polyolefin, such as a propene homopolymer or a copolymer consisting of propene and ethene and/or another alkene. In this connection, preference is given to the drinking straw being manufactured entirely from such a material, including the inorganic-filler material(s).

According to another aspect of the invention, the said polyolefin includes a polyalkene-based polyolefin, preferably a polyethene-based polyolefin and, even more preferably, a polyolefin which consists of a high-density polyethene. In this connection, preference is given to the drinking straw being manufactured entirely from such a material, including the inorganic filler material(s).

According to yet another aspect of the invention, the said polyolefin or said polyolefins include the inorganic filler material in a quantity of at least 5% by weight or normally at least 10% by weight, preferably 20-85% by weight, even more preferably 30-80% by weight, and most preferably 40-80% by weight. The choice of the quantity of inorganic filler material which is intermixed is governed, inter alia, by the density which is reached. The polyolefin or the polyolefins normally have a density which is lower than 1 kg/dm³. The quantity of intermixed filler material should at least be sufficient to ensure that the density of the material exceeds 1 kg/dm³. Normally, even higher densities are required, in particular when the drinking straw is to be used in carbonated drinks. The precise amount required depends on a number of factors, such as the quantity of carbonic acid in the drink and the specific surface of the walls of the drinking straw. Expert optimizations can be used to test suitable quantities of intermixed inorganic filler material. However, it should be pointed out that the result is usually improved by using more inorganic filler material since this inorganic filler material has a substantially higher density than the polyolefins and, furthermore, is cheaper and more environmentally friendly than the polyolefins. In practice, therefore, the upper limit for the quantity of intermixed inorganic filler material is therefore set by a limit at which the material can no longer be used, in practice, for the automated mass production of drinking straws, which is normally affected by extruding followed by truncating. The inorganic filler material is expediently particulate, preferably in the form of flakes, and is in the main uniformly distributed in the polyolefin matrix. Preference is given to the particles having a particle size of 1-20 μm.

According to another aspect of the invention, the said one or more inorganic filler materials is/are selected from the group which consists of dolomite, talc, chalk, mica, limestone, marble, kaolin and wollastonite. Particular preference is given to the said inorganic filler materials including or consisting of a mixture of dolomite particles and talc particles, preferably in a proportion of 70-90% by weight of dolomite particles and 10-30% by weight of talc particles. A preferred alternative variant is that the said inorganic filler materials consist entirely or principally of chalk, even if the invention naturally encompasses any variants which include one or more inorganic filler materials.

### DESCRIPTION OF THE FIGURES

Some variants of drinking straws which can be manufactured from the material according to the invention will be described below with reference to the figures, of which:

FIG. 1 shows a straight drinking straw, seen in perspective,

FIG. 2 shows a bendable drinking straw, seen in perspective.

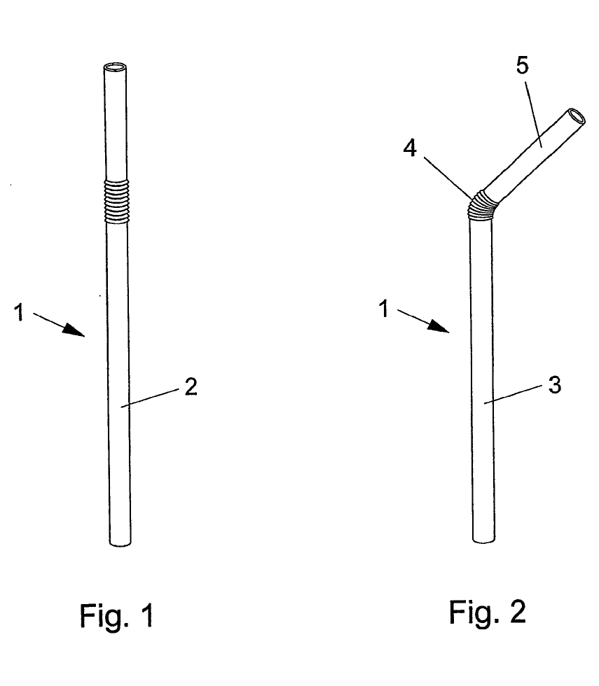

FIG. 1 shows a drinking straw 1 which is made up of a circular-cylindrical body 2 which is open at both short ends. The walls of the body are thin and preferably homogeneous in their material structure, which consists of a composite material in accordance with the invention. Typical dimensions are a length of 80-250 mm, preferably 100-200 mm, and an outer diameter of 2-10 mm, preferably 2-8 mm. The invention is in particular applicable for drinking straws having diameters in the upper range of the interval, for example 4-10 mm, preferably 5-10 mm, since the wall surface of such drinking straws is large and the net lift consequently becomes large when carbon dioxide bubbles become attached to the drinking straw. The thickness of the wall is normally well below 0.5 mm, preferably less than 0.3 mm.

FIG. 2 shows an alternative drinking straw 1 which is of a type which is known per se and which is made up of two circular-cylindrical sections 3, 5, with a pleated section 4 in between them. The drinking straw 1 can be bent in the pleated section 4. The total length, and the diameter, are in accord with the dimensions given in connection with FIG. 1. This embodiment consequently includes the small, bendable drinking straws which normally accompany sealed single-portion packs which contain drinks of, for example, 150-300 ml, usually 200-250 ml, in volume and which are provided with a prepared opening hole for the drinking straw.

The invention is not limited to the embodiments which have been described and demonstrated but can be varied within the scope of the patent claims.

1. Drinking straw for drinks, wherein it is made of a material which includes one or more polyolefins, which polyolefin or which polyolefins include one or more inorganic filler materials.

2. Drinking straw according to claim 1, wherein the said one or more polyolefins include(s) a propene-based polyolefin, preferably a propene homopolymer or a copolymer of propene and ethene and/or an other alkene.

3. Drinking straw according to claim 1, wherein the said one or more polyolefins include(s) a polyalkene-based polyolefin, preferably a polyethene-based polyolefin and, even more preferably, a polyolefin which consists of a high-density polyethene.

4. Drinking straw according to claim 1, wherein the said one or more polyolefins include(s) the said inorganic filler materials in a quantity of at least 10% by weight, preferably 20-85% by weight, even more preferably 30-80% by weight and most preferably 40-80% by weight.

5. Drinking straw according to claim 1, wherein the said one or more inorganic filler materials consist(s) of inorganic mineral particles.

6. Drinking straw according to claim 1, wherein the said one or more inorganic filler materials is/are selected from the group which consists of dolomite, talc, chalk, mica, limestone, marble, kaolin and wollastonite.

7. Drinking straw according to claim 1, wherein the said inorganic filler materials include a mixture of dolomite and talc particles, preferably in a proportion of 70-90% by weight of dolomite particles and 10-30% by weight of talc particles, calculated on the filler material.

8. Drinking straw according to claim 1, wherein the said inorganic filler materials consist entirely or principally of chalk.

9. Use of one or more polyolefins, which polyolefin or which polyolefins include one or more inorganic filler materials, as material in drinking straws for drinks.
